(19) United States
(12) Patent Application Publication
(10) Pub. No.: US 2025/0128884 A1
(43) Pub. Date: Apr. 24, 2025

(54) Spiral Chute

(71) Applicant: Stock Manufacturing and Design Co., Inc., Cleves, OH (US)

(72) Inventors: Jeremy Kirk Stock, Florence, KY (US); Jim Louis Greathouse, Loveland, OH (US); Chadwick Fox, Cincinnati, OH (US)

(21) Appl. No.: 18/918,240

(22) Filed: Oct. 17, 2024

Related U.S. Application Data
(60) Provisional application No. 63/591,636, filed on Oct. 19, 2023.

(51) Int. Cl. B65G 11/06; B65G 11/18

(52) U.S. Cl. CPC B65G 11/063; B65G 11/183

(57) ABSTRACT

A spiral chute includes a center column assembly having a column. The spiral chute further includes a plurality of support arm mounting brackets affixed to an exterior of the column in a spiral configuration. The spiral chute also includes a plurality of chute segments. Each chute segment includes a support arm having a distal end and a proximal end, a stiffener coupled to the distal end of the support arm, and a chute section operatively coupled to the support arm and the stiffener. The proximal end of each of the plurality of support arms is removably coupled to a respective support arm mounting bracket. A method of constructing a spiral chute is also disclosed.

### CROSS REFERENCE TO RELATED APPLICATION

This application claims the benefit of U.S. Provisional Patent Application Ser. No. 63/591,636, filed Oct. 19, 2023, the disclosure of which is incorporated by reference herein in its entirety.

### TECHNICAL FIELD

The invention relates generally to chutes for moving articles, and specifically, spiral chutes for moving articles downwardly from a higher location to a lower location.

### BACKGROUND

Current plastic chute designs use a fixed length stanchion and require an elaborate frame structure be connected to the stanchion to cradle and support the plastic chutes. Custom engineering is often required to meet a customer's unique on-site needs which adds to both the cost and lead time. Parts are assembled in the chute manufacturer's factory, resulting in an excessively large single piece unit that may be easily damaged and often more difficult to handle, ship, rig into the installation site, and erect at the site.

From a functional perspective, most existing designs require that all products enter from the top of the assembly. These designs do not provide access for a product to enter from the side, at different elevations and radial positions, which limits the number of products that can be fed into one chute. The few existing designs with side inlets placed at 90 degree intervals, which reduces the side inlet configurations that may be used with those existing designs.

### SUMMARY OF THE INVENTION

In one aspect of the disclosure, a spiral chute is disclosed and includes a center column assembly having a column, a plurality of support arm mounting brackets affixed to an exterior of the column in a spiral configuration, and a plurality of chute segments. Each chute segment includes a support arm having a distal end and a proximal end, a stiffener coupled to the distal end of the support arm, and a chute section operatively coupled to the support arm and the stiffener. The proximal end of each of the plurality of support arms is removably attached to a respective support arm mounting bracket.

In an embodiment, each support arm mounting bracket may have an upper portion, a middle portion, and a lower portion and each support arm has a middle portion that is attached to the middle portion of the support arm mounting bracket. Each support arm may have a lower portion that is attached to the lower portion of the support arm mounting bracket. The upper portion, middle portion, and lower portion of each support arm mounting bracket may be configured such that the support arm mounting bracket has a substantially Z-shaped cross section. The support arm may have a cross section and at least a portion of that cross section substantially conforms to the Z-shaped cross section of the support arm mounting bracket.

In an embodiment, the spiral chute may further include at least one chute section mounting bracket coupling the chute section to the support arm. The at least one chute section mounting bracket may include a first chute section mounting bracket and a second chute section mounting bracket. The first chute section mounting bracket may include a base portion coupled to the support arm and a tab portion coupled to the chute section. The second chute section mounting bracket may include a base portion coupled to the support arm and two tab portions and each of the two tab portions may be coupled to the chute section. One of the two tab portions of the second chute section mounting brackets may includes a lateral extension portion with a through hole therein.

In another embodiment, the plurality of the support arm mounting brackets may be permanently affixed to the exterior of the column. For example, the support arm mounting brackets may be welded to the exterior of the column.

In an embodiment, the spiral chute may further include a base assembly disposed at a lower end of the column. The base assembly may be configured to be affixed to a support surface. The base assembly may be selectively detachable from the column.

In another aspect of the disclosure, a method of constructing a spiral chute includes securing a column to a support surface. The column has a plurality of support arm mounting brackets affixed to an exterior surface of the column in a spiral configuration. The method further includes providing a plurality of chute segments, where each chute segment has a support arm having a distal end and a proximal end, a stiffener coupled to the distal end of the support arm, and chute section operatively coupled to the support arm and the stiffener. The method also includes attaching the proximal end of each of the plurality of support arms to respective ones of the plurality of support arm mounting brackets.

In an embodiment, each support arm mounting bracket may have an upper portion, a middle portion, and a lower portion and each support arm has a middle portion. The step of attaching the proximal end to the support arm mounting brackets may include attaching the middle portion of the support arm to the middle portion of the support arm mounting bracket. Each support arm may have a lower portion and the step of attaching the proximal end to the support arm mounting brackets may include attaching the lower portion of the support arm to the lower portion of the support arm mounting bracket. The upper portion, middle portion, and lower portion of each support arm mounting bracket may be configured such that the support arm mounting bracket has a substantially Z-shaped cross section. The support arm has a cross section and at least a portion of that cross section substantially may conform to the Z-shaped cross section of the support arm mounting bracket.

In an embodiment, the support arm mounting brackets may be welded to the exterior of the column.

In an embodiment, prior to securing the column to the support surface, the method may further include providing a locating fixture with a plurality of tabs with a space between adjacent tabs and positioning the locating fixture along the exterior of the column. The method further includes placing at least two of the plurality of support arm mounting brackets into respective spaces of the locating fixture, affixing the support arm mounting brackets to the exterior of the column, and removing the locating fixture from the exterior of the column.

### BRIEF DESCRIPTION OF THE DRAWINGS

The accompanying drawings, which are incorporated in and constitute a part of this specification, illustrate one or more embodiments of the invention and, together with a general description of the invention given above, and the detailed description given below, serve to explain the invention.

FIG. 1 is a perspective view of a spiral chute according to an exemplary embodiment of the disclosure.

FIG. 2 is another perspective view of the spiral chute of FIG. 1.

FIG. 3A is a partially disassembled perspective view of a center column assembly and a base of the spiral chute of FIG. 1.

FIG. 3B is a partially disassembled elevational view of the center column assembly and base of the spiral chute of FIG. 1.

FIG. 3C is a perspective view of the center column assembly of FIG. 3A with support arm mounting brackets being temporarily secured to the column with a locating fixture so the support arm mounting brackets may be affixed to the column, such as by welding.

FIGS. 4A-4B are elevational views of a locating fixture used to space support arm mounting brackets on the column of a center column assembly.

FIG. 5A is a partially disassembled perspective view of the spiral chute of FIG. 1 with a chute support arm and a chute section prior to being affixed to the stanchion.

FIG. 5B is a partially disassembled perspective view of the spiral chute of FIG. 1 with the chute support arm and the chute section prior to being affixed to the stanchion.

FIG. 5C is a partially disassembled perspective view of the spiral chute of FIG. 1 with the chute sport arm and the chute section affixed to the stanchion.

FIG. 5D is another partially disassembled perspective view of the spiral chute of FIG. 1 with the chute support arm and the chute section affixed to the stanchion.

FIG. 6A is an elevational view of the stanchion with a mount bracket, a chute support arm, and a chute section in cross section.

FIG. 6B is an elevational view of the stanchion with two mount brackets, two chute support arms, and two chute sections in cross section.

FIG. 7A is a perspective view of a chute mounting bracket.

FIG. 7B is an elevational view of the chute mounting bracket of FIG. 7A.

FIG. 8A is a perspective view of a chute mounting bracket.

FIG. 8B is an elevational view of the chute mounting bracket of FIG. 8A.

FIG. 9A is a perspective view of a chute mounting bracket.

FIG. 9B is an elevational view of the chute mounting bracket of FIG. 9A.

FIG. 10 is a perspective view of a spiral chute according to another exemplary embodiment of the disclosure with a separable base assembly.

FIG. 11 is a perspective view of a spiral chute according to another exemplary embodiment of the disclosure.

FIG. 12 is a partially disassembled perspective view of the spiral chute of FIG. 11 with a chute support arm and a chute section prior to being affixed to the stanchion.

FIG. 13 is a perspective view of a spiral chute according to another exemplary embodiment of the disclosure.

### DETAILED DESCRIPTION OF THE INVENTION

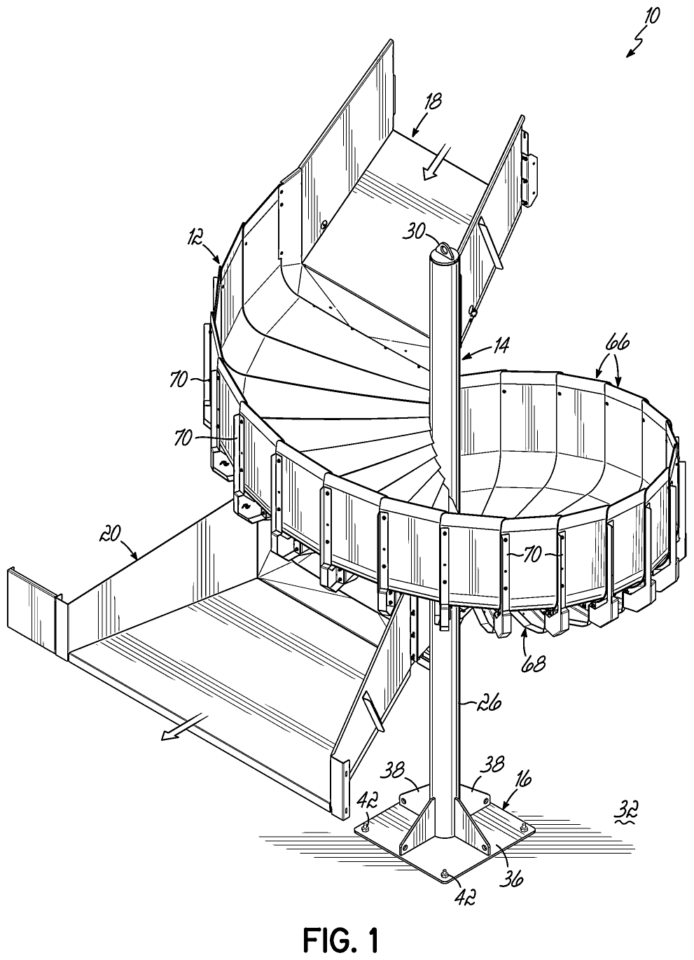

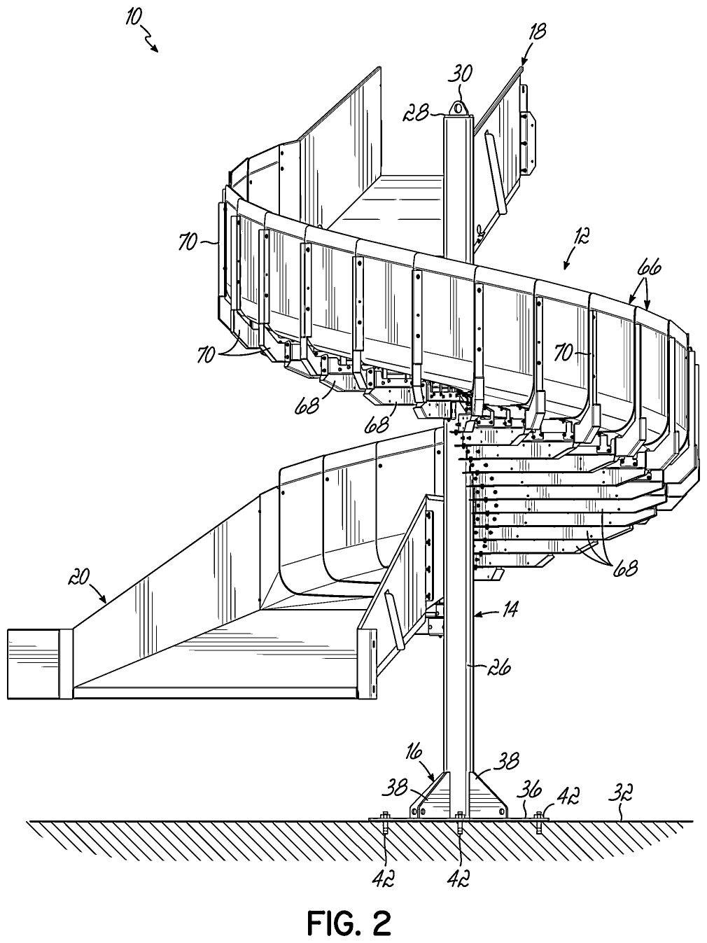

A spiral chute 10 according to one aspect of the disclosure is shown in FIGS. 1 and 2. The spiral chute 10 includes a main chute assembly 12, a center column assembly 14, a base assembly 16, an infeed chute assembly 18, and a discharge chute assembly 20. The main chute assembly 12 shown in FIGS. 1 and 2 makes one complete rotation (360°) around the center column assembly 14 such that where the infeed chute assembly 18 attaches to the main chute assembly 12 is positioned essentially directly above where the discharge chute assembly 20 attaches to the main chute assembly 12. Because of the modular design of the spiral chute 10, the degree to which the main chute assembly 12 traverses around the center column assembly 14 can vary from as little as 15° to any angle greater than 360°. In most installations, the main chute assembly 12 will be constructed in 90° increments. In that respect, the main chute assembly 12 in FIGS. 1 and 2 is considered to be made up of four 90° increments. The spiral chute 10 shown in FIGS. 1 and 2 is considered a left-hand turn chute. The spiral chute 10 may be constructed as a right-hand turn chute as well. The center column assembly 14 may be of any desired height to accommodate any spacing between an upper level transporting articles and a lower level receiving those articles.

In an embodiment, the spiral chute 10 may also include a side entry chute (not shown) coupled onto the main chute assembly 12 somewhere between the infeed chute assembly 18 and the discharge chute assembly 20. The side entry chute may receive articles coming from a different vertical level relative to the articles received by the infeed chute assembly 18.

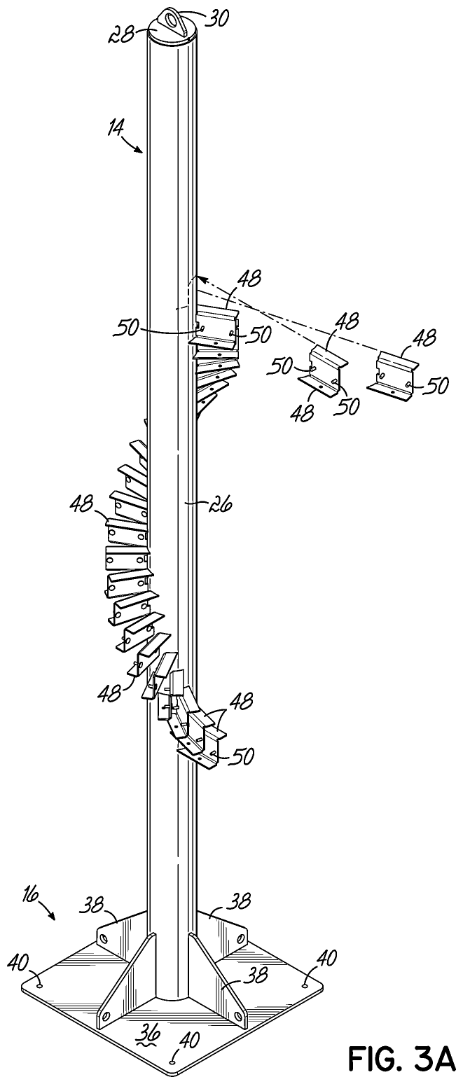

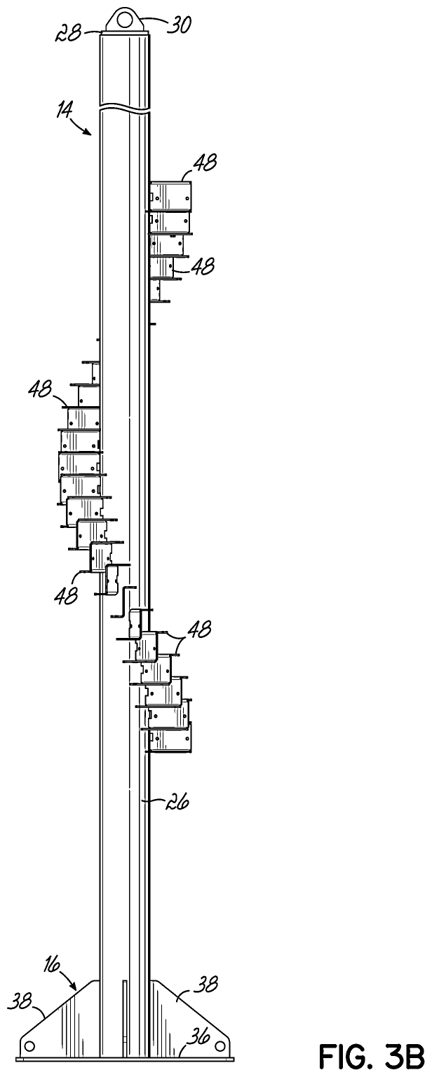

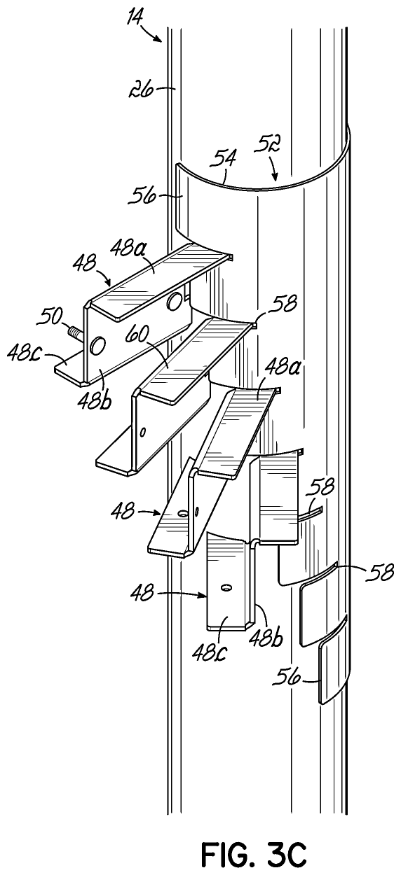

With reference to FIGS. 3A and 3B, the center column assembly 14 and the base assembly 16 are illustrated with the main chute assembly 12 removed for the sake of clarity. The center column assembly 14 includes a column 26 with a cap 28 and a lifting lug 30. A lifting device may be attached to the lifting lug 30 so the center column assembly 14 may be lifted and positioned at a desired location on a support surface 32 (FIG. 2). The column 26 is shown as one piece in FIGS. 3A and 3B, but the column 26 may comprise a plurality of segments that are coupled together. The base assembly 16 includes a base plate 36 and base gussets 38 that are affixed to the exterior surface of the column 26. The base plate 36 includes a plurality of an anchor holes 40 through which base anchors 42 are used to secure the center column assembly 14 to the support surface 32 as shown in FIG. 2.

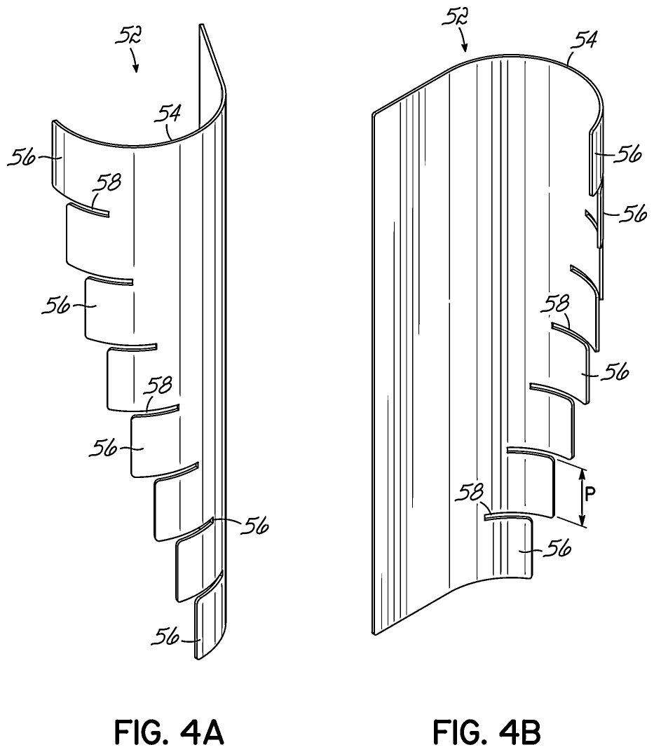

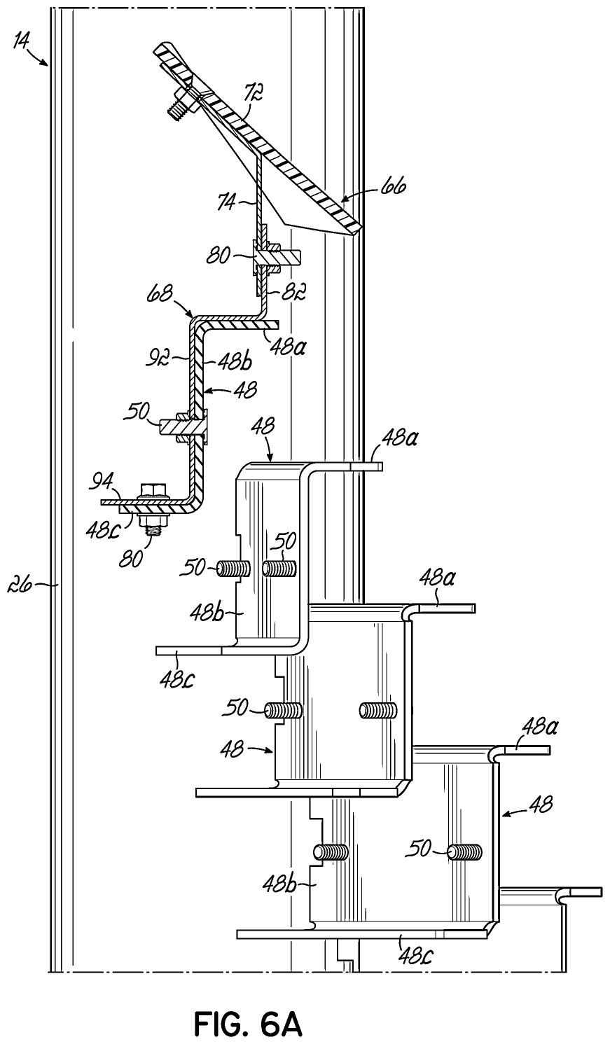

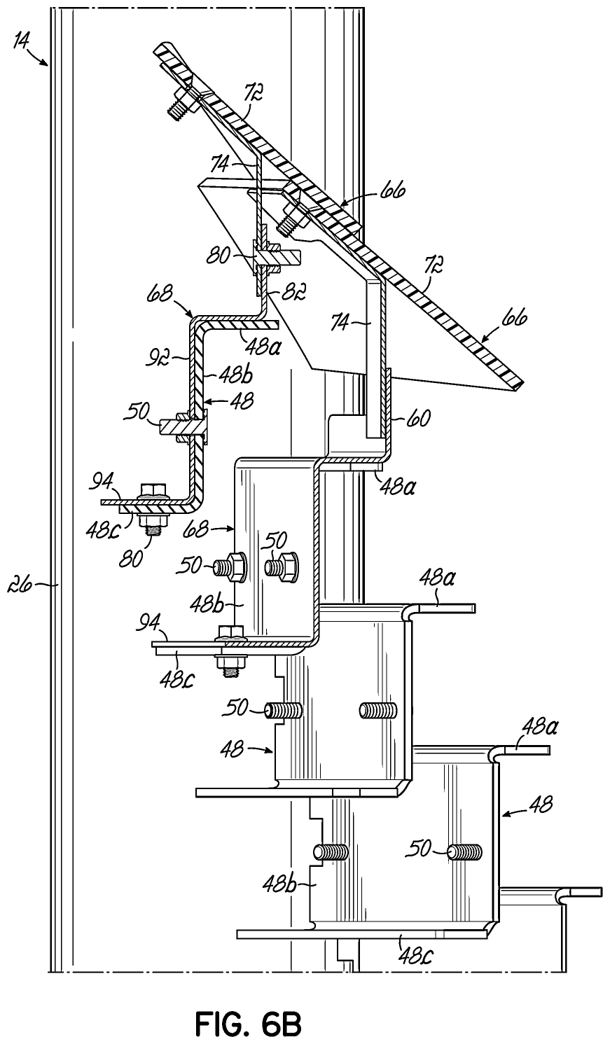

With continued reference to FIGS. 3A and 3B, a series of support arm mounting brackets 48 are shown extending along the length of the column 26 in a helical or spiral configuration. Each support arm mounting bracket 48 may be individually coupled to the column 26 by any suitable means, such as welding for example. In an embodiment, each support arm mounting bracket 48 may have an upper portion 48a, a middle portion 48b, and a lower portion 48c configured such that the support arm mounting bracket 48 has a substantially Z-shaped cross section similar to a Z channel (see FIG. 6A) as that term is understood in the art. The support arm mounting bracket 48 may be configured to have other cross-sectional shapes as well. Support arm mounting studs 50 may be affixed to the support arm mounting brackets 48 either before or after the support arm mounting brackets 48 are attached to the column 26. To assist with coupling the support arm mounting brackets 48 to the column 26, a locating fixture 52 (FIGS. 4A-4B) may be used. The locating fixture 52 includes a curved portion 54 that substantially matches the curvature of the outer surface of the column 26. The locating fixture 52 also includes a series of tabs 56 with a space 58 between each tab 56. The space 58 is sized to allow for the upper portion 48a of the support arm mounting bracket 48 to be placed inside the space 58 and held at a desired vertical position along the length of the column 26. As shown in FIG. 3D, when the locating fixture 52 is temporarily secured to the column 26, the upper portion 48a of one support arm mounting bracket 48 may be placed into one space 58 and the support arm mounting bracket 48 is secured to the column 26 by any suitable means such as welding, for example. Another support arm mounting bracket 48 may engage the locating fixture 52 and it may be secured to the column 26. This process continues until all the spaces 58 are filled with support arm mounting brackets 48 and the support arm mounting brackets 48 are secured to the column 26. The locating fixture 52 is removed from the column 26 and is moved to another vertical location on the column 26, such as directly below the lowest support arm mounting bracket 48 on the column 26. The process of securing support arm mounting brackets 48 to the column 26 continues until a predetermined number of support arm mounting brackets 48 are secured to construct a helical or spiral configuration along a portion of the length of the column 26. The pitch, i.e., the vertical distance between two adjacent support arm mounting brackets 48, is set by a distance P between to adjacent spaces 58. The pitch may be 3 inches or 4 inches or any other suitable distance. The locating fixture 52 may be configured to construct a left-hand helical or spiral of support arm mounting brackets 48 as shown in FIGS. 3A and 3B. A locating fixture may also be configured to construct a right-hand helical or spiral of support arm mounting brackets. The support arm mounting brackets 48 shown in FIGS. 3A and 3B are configured to construct the left-hand helical or spiral. To create a right-hand helical or spiral, different support arm mounting brackets would be used.

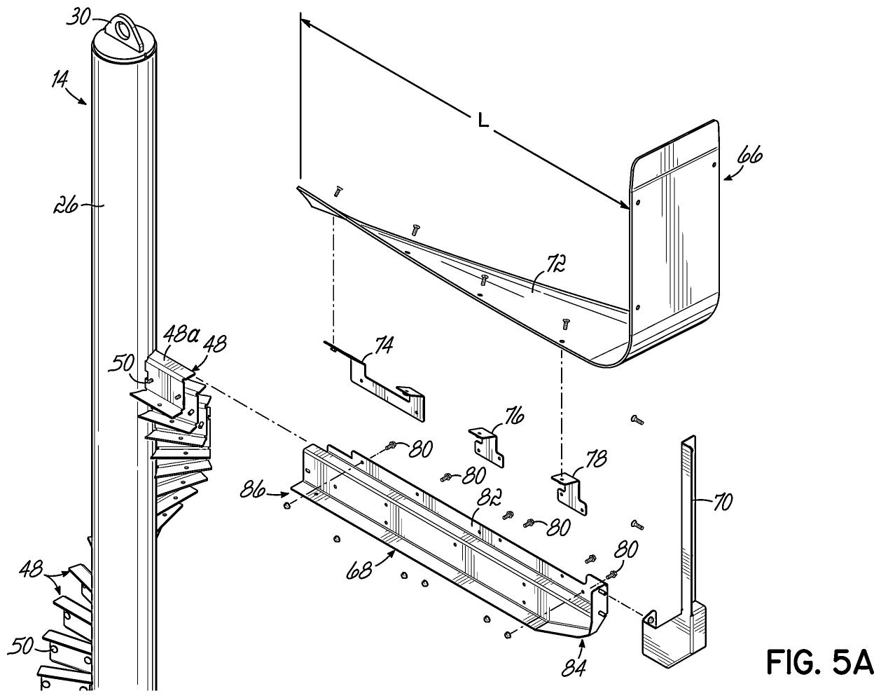

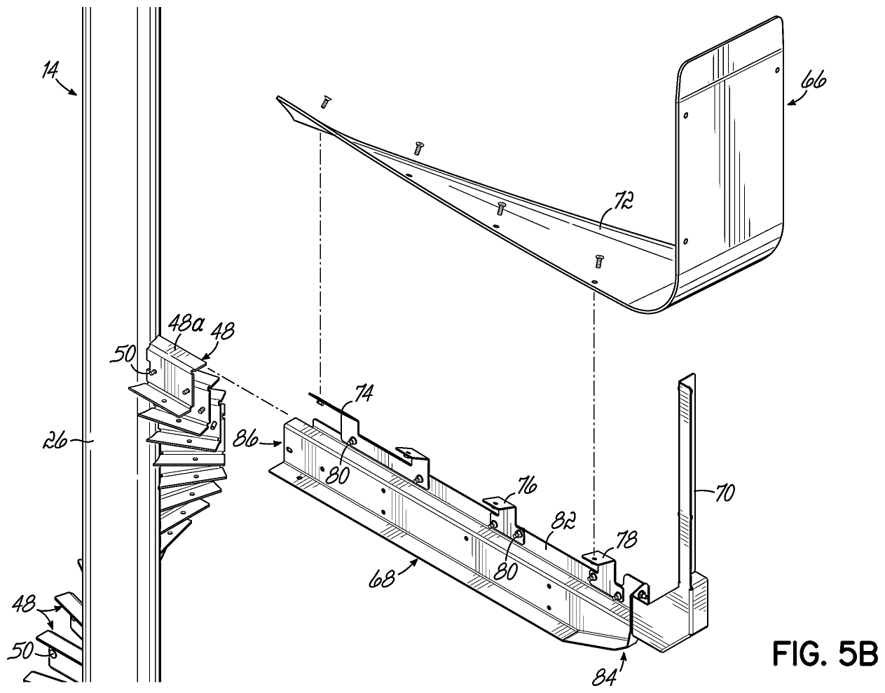

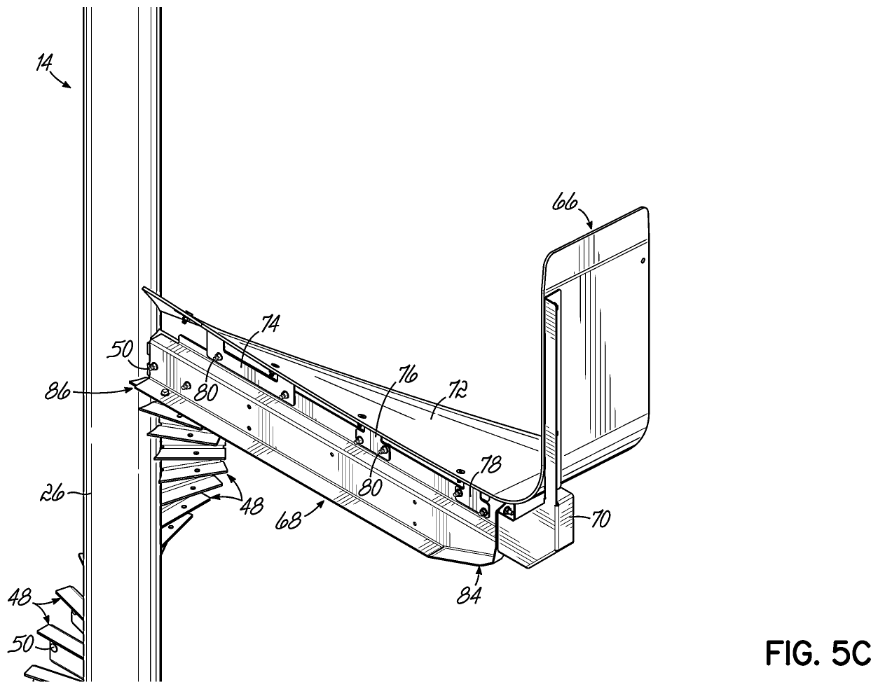

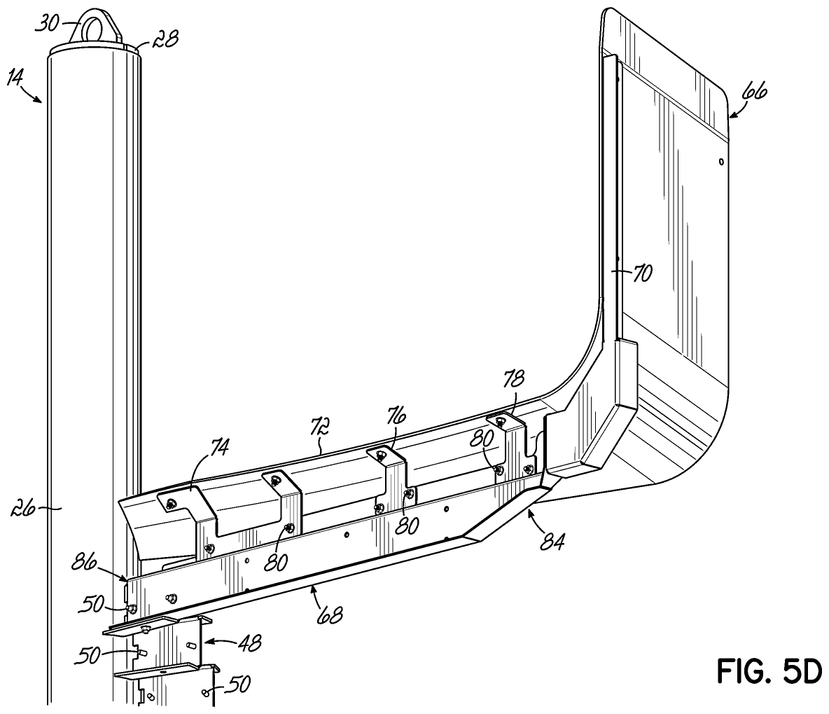

FIGS. 5A-5D show one chute segment 66 of the main chute assembly 12 being assembled and attached to one of the support arm mounting brackets 48. With reference to FIG. 5A, the chute segment 66 includes a support arm 68, a stiffener 70, a chute section 72, a plurality of chute section mounting brackets 74, 76, 78, and a plurality of fasteners 80 for coupling the various components of the chute segment 66 together. The chute section 72 has a length L as shown in FIG. 5A. Depending on the application of the spiral chute 10, the length L of the chute section 72 may be in the range of 24-60 inches, although smaller and larger lengths L are possible. The fasteners 80 may be any suitable fastener to join components together, such as a nut and bolt or screws, for example. Some of the bolts may have socket heads or flat heads depending upon what is needed by the installation application. The chute section 72 may be constructed on any suitable material such as UHMW or recycled UHMW, mild steel, stainless steel, fiberglass, and the like. The material, including the UHMW, may include anti-static components to prevent static build up as the articles slide down the spiral chute 10. In FIG. 5B, the chute section mounting brackets 74, 76, 78 are attached to an upper portion 82 of the support arm 68 using fasteners 80. In addition, the stiffener 70 is attached to a distal end 84 of the support arm 68 using fasteners 80. In FIGS. 5C and 5D, a proximal end 86 of the support arm 68 is attached to the support arm mounting bracket 48 using fasteners 80.

FIG. 6A shows a cross-sectional view of one chute segment 66 of the main chute assembly 12 attached to the support arm mounting bracket 48. During assembly, the two through holes at the proximal end 86 of the support arm 68 are aligned with and around the two support arm mounting studs 50 and nuts are threaded on to the support arm mounting studs 50 to secure a middle portion 92 of the support arm 68 is the support arm mounting bracket 48. In addition, one fastener 80 is used to attach a lower portion 94 of the support arm 68 to the support arm mounting bracket 48. FIG. 6B shows a cross-sectional view of two chute segments 66 of the main chute assembly 12 attached to respective support arm mounting brackets 48. The up-stream chute section 72 overlies the down-stream chute section 72 so articles in the main chute assembly 12 may move unobstructed over the chute sections 72.

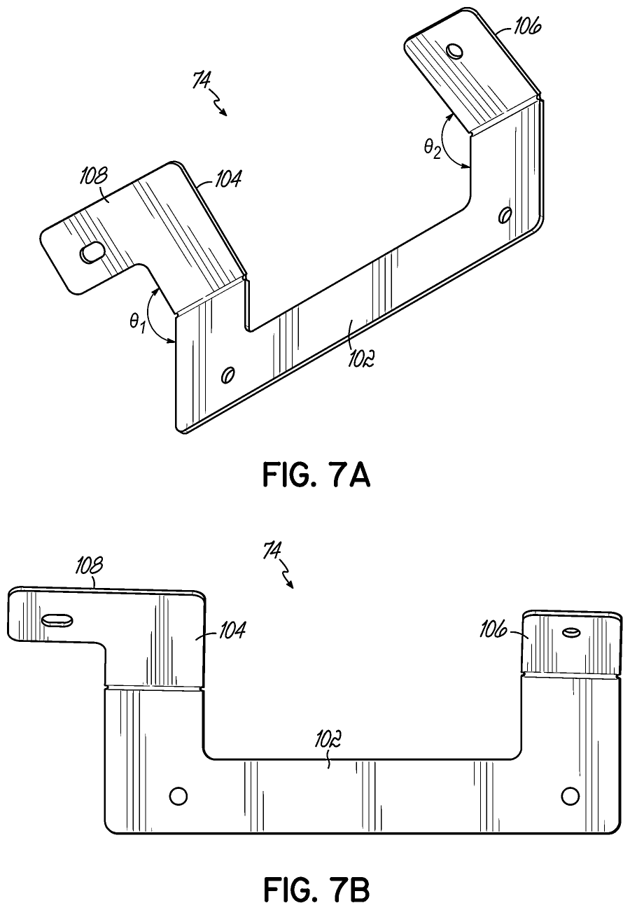

FIGS. 7A-9B show the individual chute section mounting brackets 74, 76, 78. Each of the chute section mounting brackets 74, 76, 78 have a slight different profile to accommodate a twist in a lateral portion 100 (FIG. 5A) of the chute section 72. The lateral portion 100 has more twist near the column 26 and less twist away from the column 26. As shown in FIG. 7A, chute section mounting bracket 74 has a base portion 102 and a first and second tab portions 104, 106. An angle θ₁ is defined between base portion 102 and first tab portion 104 and an angle θ₂ is defined between base portion 102 and second tab portion 106. Because the twist of the lateral portion 100 is greater near the column and decreases further from the column 26, the angle θ₁ is greater than the angle θ₂ of chute mounting bracket 74. The spacing between adjacent support arms 68 gets smaller as the adjacent support arms 68 attached to the support arm mounting brackets 48 at the column 26. As such, the first tab portion 104 may include a lateral extension portion 108 that displaces the through hole towards the column 26, so that the fastener 80 attaching the chute section 72 to the chute section mounting bracket 74 does not interfere with or contact the upstream support arm 68.

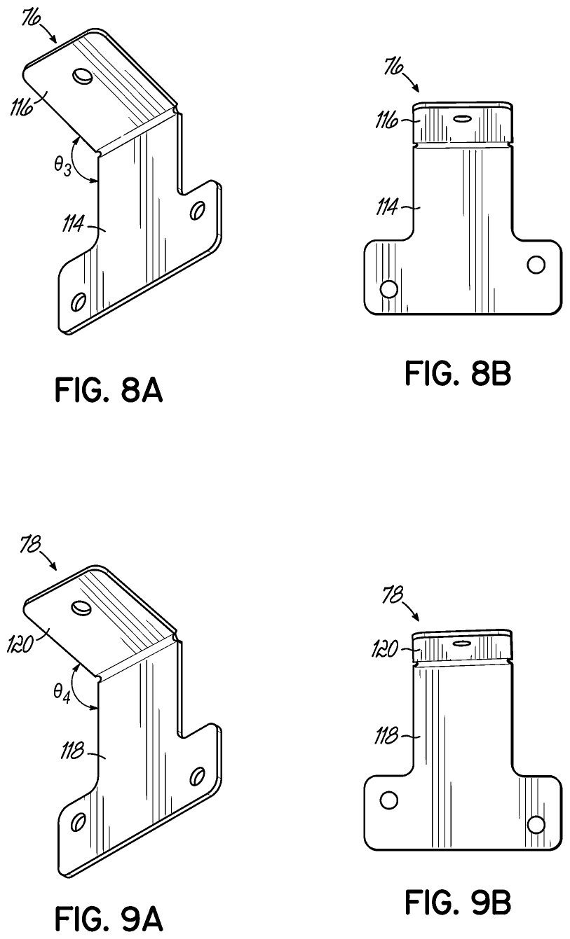

As shown in FIG. 8A, chute section mounting bracket 76 includes a base portion 114 and a tab 116 which define an angle θ₃ therebetween. As shown in FIG. 9A, the chute section mounting bracket 78 includes a base portion 118 and a tab 120 which define an angle θ₄ therebetween. Because chute section mounting bracket 76 is positioned radially inward of chute section mounting bracket 78 and the twist of chute section 72 is greater at chute section mounting bracket 76, the angle θ₃ is greater than the angle θ₄.

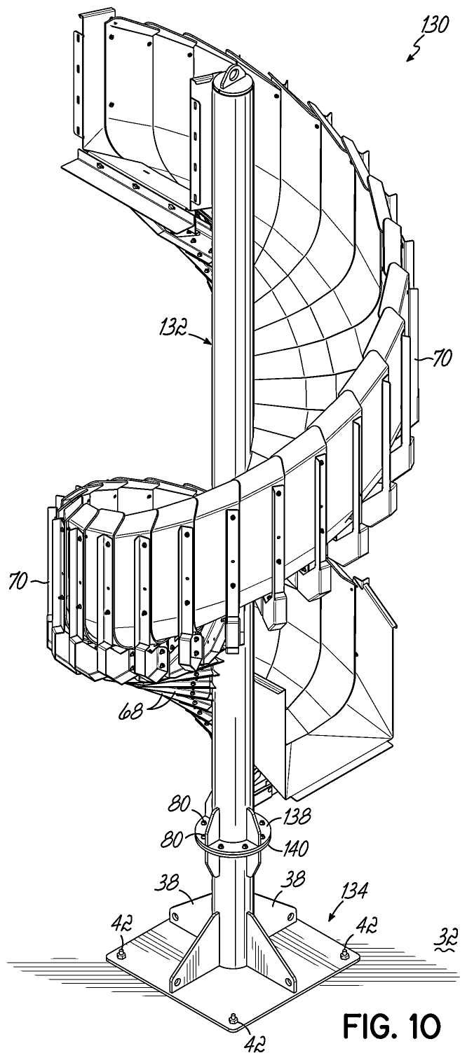

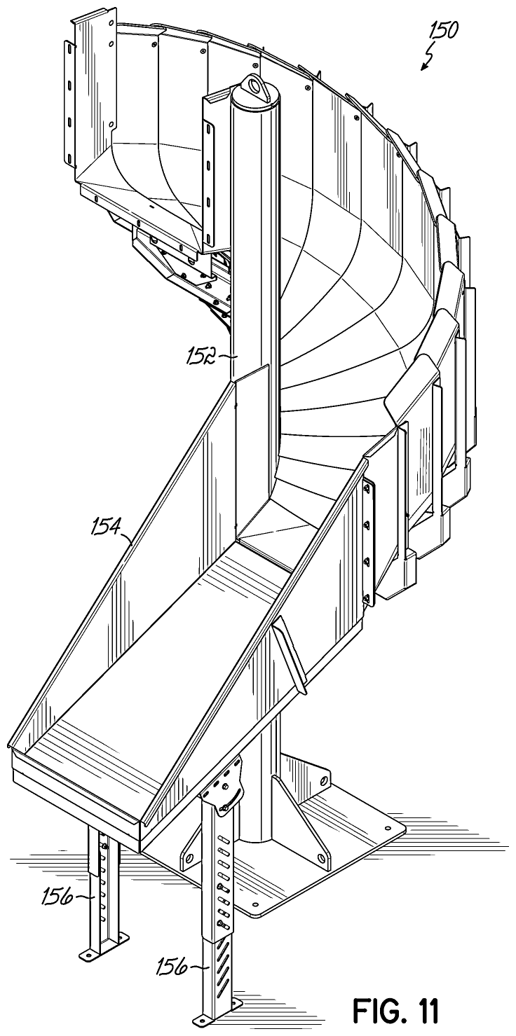

Another embodiment of a spiral chute 130 is shown in FIG. 10. The spiral chute 130 is constructed similar to the spiral chute 10 with many of the same components, including chute segments 66 and support arm mounting brackets 48, for example. Unlike spiral chute 10, spiral chute 130 is a right-handed chute and rotates 450 degrees around a column 132. The spiral chute 130 further includes a base assembly 134 that may be removably attached to the column 132 at a junction 136. The bottom of column 132 may have a mounting plate 138 and the top of the base assembly may have a complimentary mounting plate 140. During assembly the mounting plate 140 is coupled to the mounting plate 138 with fasteners 80. The base assembly 134 may include the same base plate 36 and base gussets 38 as base assembly 16. With the base assembly 134 being separable from the column 132, the base assembly 134 may be more readily leveled and secured to the supporting surface 32 with base anchors 42. Once the base assembly 134, the mounting plate 138 of the column 132 may be secured to the mounting plate 140 of the base assembly 134.

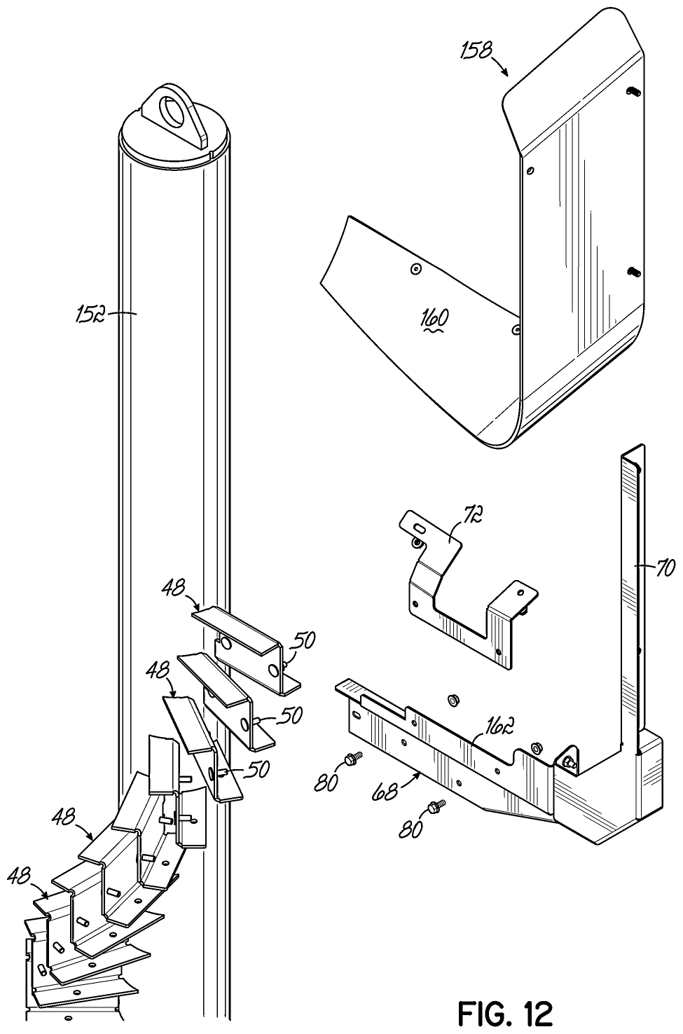

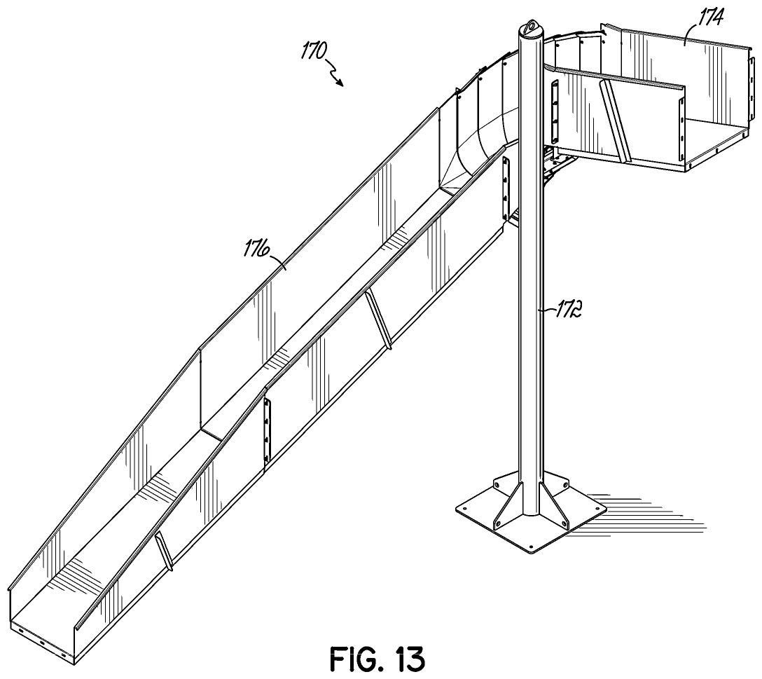

Another embodiment of a spiral chute 150 is shown in FIGS. 11 and 12. The spiral chute 150 is constructed similar to the spiral chute 10 with many of the same components. Spiral chute 150 is a right-handed chute and rotates about 180 degrees around a column 152. The spiral chute includes a discharge chute assembly 154 that is supported by adjustable legs 156. The spiral chute 150 has a narrower chute width compared to the chute width of spiral chute 10. As such, a chute segment 160 of a chute section 158 has a length L which is less than the length L of chute section 72 of chute section 66 of spiral chute 10. Compared to the components of chute segment 66, chute segment 158 includes a short chute section 160, a shorter support arm 162, and a modified chute section mounting bracket 164. Other than the dimensional differences, the spiral chute 150 is assembled in a manner similar to the assembly of spiral chute 10.

Another embodiment of a spiral chute 170 is shown in FIG. 13. The spiral chute 170 is constructed similar to the spiral chute 10 with many of the same components. Spiral chute 170 is a left-handed chute and rotates about 90 degrees around a column 172. The spiral chute 170 includes an infeed chute assembly 174 and a discharge chute assembly 176.

Each of the spiral chutes 10, 130, 150, 170 illustrates the flexibility of the chute design, such as left-or right-handed, different amounts of rotation of the chute around a column, different pitches, and different infeed and discharge chute assemblies. Such flexibility means the inventive spiral chute may be used in a wide variety of applications for transporting articles from one level to another level in a warehouse environment for example.

The invention also contemplates a method for constructing the spiral chute 10. One exemplary, non-limiting assembly methodology is described below. Variations of the described methodology are within the scope of the invention. The method described below assumes that the center column assembly 14 already has the support arm mounting brackets 48 attached and the base assembly 16 is attached to the center column assembly 14 similar to what is shown in FIG. 3B. In another embodiment, the method may include attaching the support arm mounting brackets 48 to an exterior of the column 26. The attaching step may include spacing the support arm mounting brackets 48 a predetermined vertical distance and a predetermined radial distance to thereby form a spiral configuration of the support arm mounting brackets 48 along the column. The attaching at predetermined vertical and radial distances may be facilitated using the locating fixture 52 as described above.

At the installation site, the method includes positioning the center column assembly 14 and the attached base assembly in a desired location on the support surface 32 and securing the base assembly to the support surface 32 with base anchors 42. Shims or jack pads may be placed under the base plate to ensure the center column assembly 14 is substantially vertical. Lift the infeed chute assembly 18 to the top most support arm mounting bracket 48 and attach the infeed chute assembly 18 using the support arm mounting studs 50 and one fastener 80. Place one chute segment 66 onto the next lower support arm mounting bracket 48 immediately below the infeed chute assembly 18 and secure it with the support arm mounting studs 50 and one fastener 80. The chute section 72 should be properly “shingled”, i.e., placed under the infeed chute assembly 18 so articles flow unimpeded out of the infeed chute assembly 18. Attach the top of the chute section 72 to the top of the infeed chute assembly 18 using one fastener 80. Continue to place additional chute segments 66 down the column 26 using the next lower support arm mounting bracket 48. For any pair of adjacent chute segments 66, the top of the upper chute section 72 of the lower chute segment 66 should be attached to the top of the upper chute section 72 of the upper chute segment 66 using one fastener 80 placed through the two chute sections 72 and the stiffener 70 of the lower chute segment 66. After the lowest chute segment 66 is attached to the center column assembly 14, the discharge chute assembly 20 may be attached to the lowest support arm mounting bracket 48. In an embodiment, the method may further include mounting a side entry chute disposed between the infeed chute assembly 18 and the discharge chute assembly 20.

While the method for constructing the spiral chute 10 discussed above, starts at the top of the column 26 works downward, the construction process may start at the bottom of the column 26 and work upwards. In addition, the spiral chute 10 may be assembled fully or partially offsite and then brought to the installation site, where it may be secured to the support surface 32 and then completed as needed.

While the invention has been illustrated by a description of various embodiments, and while these embodiments have been described in considerable detail, it is not the intention of the Applicant to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the spirit or scope of the Applicant's general inventive concept.

1. A spiral chute comprising:
a center column assembly having a column;
a plurality of support arm mounting brackets affixed to an exterior of the column in a spiral configuration; and
a plurality of chute segments, each chute segment including:
a support arm having a distal end and a proximal end;
a stiffener coupled to the distal end of the support arm; and
a chute section operatively coupled to the support arm and the stiffener,
wherein the proximal end of each of the plurality of support arms is removably attached to a respective support arm mounting bracket.

2. The spiral chute of claim 1, wherein each support arm mounting bracket has an upper portion, a middle portion, and a lower portion and wherein each support arm has a middle portion that is attached to the middle portion of the support arm mounting bracket.

3. The spiral chute of claim 2, wherein each support arm has a lower portion and wherein the lower portion of the support arm is attached to the lower portion of the support arm mounting bracket.

4. The spiral chute of claim 2, wherein the upper portion, middle portion, and lower portion of each support arm mounting bracket are configured such that the support arm mounting bracket has a substantially Z-shaped cross section.

5. The spiral chute of claim 4, wherein the support arm has a cross section and at least a portion of that cross section substantially conforms to the Z-shaped cross section of the support arm mounting bracket.

6. The spiral chute of claim 1, further comprising:
at least one chute section mounting bracket coupling the chute section to the support arm.

7. The spiral chute of claim 6, wherein the at least one chute section mounting bracket includes a first chute section mounting bracket and a second chute section mounting bracket, the first chute section mounting bracket includes a base portion coupled to the support arm and a tab portion coupled to the chute section, the second chute section mounting bracket includes a base portion coupled to the support arm and two tab portions, each of the two tab portions coupled to the chute section.

8. The spiral chute of claim 7, wherein one of the two tab portions of the second chute section mounting brackets includes a lateral extension portion with a through hole therein.

9. The spiral chute of claim 1, wherein the plurality of the support arm mounting brackets are permanently affixed to the exterior of the column.

10. The spiral chute of claim 9, wherein the support arm mounting brackets are welded to the exterior of the column.

11. The spiral chute of claim 1, further comprising:
a base assembly disposed at a lower end of the column, the base assembly configured to be affixed to a support surface.

12. The spiral chute of claim 11, wherein the base assembly is selectively detachable from the column.

13. A method of constructing a spiral chute comprising:
securing a column to a support surface, the column having a plurality of support arm mounting brackets affixed to an exterior surface of the column in a spiral configuration;
providing a plurality of chute segments, each chute segment having a support arm having a distal end and a proximal end, a stiffener coupled to the distal end of the support arm, and chute section operatively coupled to the support arm and the stiffener; and
attaching the proximal end of each of the plurality of support arms to respective ones of the plurality of support arm mounting brackets.

14. The method of claim 13, wherein each support arm mounting bracket has an upper portion, a middle portion, and a lower portion and wherein each support arm has a middle portion,
wherein the step of attaching the proximal end to the support arm mounting brackets includes attaching the middle portion of the support arm to the middle portion of the support arm mounting bracket.

15. The method of claim 14, wherein each support arm has a lower portion,
wherein the step of attaching the proximal end to the support arm mounting brackets includes attaching the lower portion of the support arm to the lower portion of the support arm mounting bracket.

16. The method of claim 14, wherein the upper portion, middle portion, and lower portion of each support arm mounting bracket are configured such that the support arm mounting bracket has a substantially Z-shaped cross section.

17. The method of claim 16, wherein the support arm has a cross section and at least a portion of that cross section substantially conforms to the Z-shaped cross section of the support arm mounting bracket.

18. The method of claim 13, wherein the support arm mounting brackets are welded to the exterior of the column.

19. The method of claim 13, wherein prior to securing the column to the support surface, the method further comprising:
providing a locating fixture with a plurality of tabs with a space between adjacent tabs;
positioning the locating fixture along the exterior of the column;
placing at least two of the plurality of support arm mounting brackets into respective spaces of the locating fixture;
affixing the support arm mounting brackets to the exterior of the column; and
removing the locating fixture from the exterior of the column.
